(19) United States
(12) Patent Application Publication
(10) Pub. No.: US 2019/0161198 A1
(43) Pub. Date: May 30, 2019

(54) PIVOTING AXIS FOR AN AIRCRAFT ENGINE ATTACHMENT

(71) Applicant: Airbus Operations SAS, Toulouse (FR)

(72) Inventors: Stéphane COMBES, BUZET SUR TARN (FR); Jean GELIOT, TOULOUSE (FR); Thomas DEFORET, TOULOUSE (FR); Adeline SOULIE, VERDUN SUR GARONNE (FR); Benoit ORTEU, TOULOUSE (FR)

(21) Appl. No.: 16/195,971

(22) Filed: Nov. 20, 2018

(30) Foreign Application Priority Data
Nov. 24, 2017 (FR) 1761142

(51) Int. Cl. B64D 27/26

(52) U.S. Cl. CPC B64D 27/26; B64D 2027/266; B64D 2027/268

(57) ABSTRACT

A swivel axis for an aircraft engine attachment, comprising a tubular main axis which has, at a first end, a head and, at a second end, a threaded portion onto which is screwed a first nut. A fail-safe axis is configured to be mounted to swivel inside the main axis. The fail-safe axis has, at a first end, a head and, at a second end, a threaded portion onto which is screwed a second nut. The fail-safe axis is linked by an axial link to the first nut. Since the fail-safe axis is linked to the first nut, it is necessarily inserted into the main axis when the first nut is screwed onto the main axis.

### CROSS-REFERENCES TO RELATED APPLICATIONS

This application claims the benefit of the French patent application No. 1761142 filed on Nov. 24, 2017, the entire disclosures of which are incorporated herein by way of reference.

### BACKGROUND OF THE INVENTION

The present application relates to an improved swivel axis for an aircraft engine attachment.

According to a configuration that can be seen in FIGS. 1 and 2, an aircraft 10 comprises several engine assemblies 12 which are positioned under the wings 14 of the aircraft 10.

An engine assembly 12 comprises an engine 16, a nacelle (not represented in FIG. 2) positioned around the engine 16 and a pylon 18 which ensures the link between the engine 16 and the rest of the aircraft 10, in particular the wing 14.

The pylon 18 comprises a primary structure 20 which is linked to the engine 16 by a rear engine attachment 22, a front engine attachment 24 and a pair of torque arms 26 responsible for taking up the thrust loads.

As illustrated in FIG. 3, the rear engine attachment 22 comprises a triangular plate 28 inserted between the primary structure 20 of the pylon 18 and the engine 16.

The rear engine attachment 22 also comprises a yoke joint 30, secured to the primary structure 20, linked to the triangular plate 28 by a swivel axis 32.

According to an embodiment that can be seen in FIG. 4, the swivel axis 32 supports, in the central part, a ball joint 34, linking the swivel axis 34 and the triangular plate 28, and two plain bearings 36, 36′, disposed on either side of the ball joint 34, linking the swivel axis 34 and the branches of the yoke joint 30.

The swivel axis 32 comprises a tubular first axis 38, called main axis, and a tubular second axis 40, called fail-safe axis, coaxial to the main axis 38 and mounted inside the latter.

The outer diameter of the fail-safe axis 40 is slightly less than the inner diameter of the main axis 38 so as not to engage the fail-safe axis 40 inside the main axis 38 in normal operation.

The main axis 38 comprises, at a first end, a head 42 configured to bear, in operation, against a first branch of the yoke joint 30 and/or a first plain bearing 36 and, at a second end, a threaded portion 44 onto which a nut 46 equipped with a braking system is screwed. When it is tightened, this nut 46 bears against a second branch of the yoke joint 30 and/or a second plain bearing 36′.

The fail-safe axis 40 comprises, at a first end, a head 48 configured to bear, in operation, against the head 42 of the main axis 38 and, at a second end, a threaded portion 50 onto which a nut 52 equipped with a braking system is screwed. When it is tightened, this nut 52 bears against the second end of the main axis 38.

To be able to tighten the nut 46, the head 42 of the main axis 38 has, on its face oriented towards the head 48 of the fail-safe axis 40, two diametrically opposite hollows 54 configured to receive two pins 56 secured to the head 48 of the fail-safe axis 40. In addition, the head 48 of the fail-safe axis 40 comprises, at the periphery, two flats to keep it, using a wrench, rotationally immobile.

In normal operation, only the main axis 38 is loaded.

When inspecting the correct operation of the swivel axis 32, after removing the nut 52, an operator tries to swivel the fail-safe axis 40 inside the main axis 38. If the fail-safe axis 40 cannot swivel, that means that the main axis 38 is defective and the swivel axis 32 must be repaired.

On completing the inspection, it is imperative that the fail-safe axis 40 be correctly refitted.

Now, the presence of the fail-safe axis 40 is not necessary for mounting and tightening the main axis 38 if a pin wrench cooperating with the hollows 54 of the head 42 is used to immobilize the main axis 38 when tightening the nut 46.

Moreover, even if the fail-safe axis 40 is inserted into the main axis and it is rotationally immobilized with a wrench to rotationally immobilize the main axis 38, the fail-safe axis 40 can, in operation, exit from the main axis 38 if the operator forgets to screw the nut 52 equipped with its braking system.

The present invention aims to remedy the drawbacks of the prior art.

### SUMMARY OF THE INVENTION

To this end, a subject of the invention is a swivel axis for an aircraft engine attachment, comprising:

a tubular main axis which has, at a first end, a head and, at a second end, a threaded portion,

a first nut configured to be screwed onto the threaded portion of the main axis,

a fail-safe axis configured to be mounted to swivel inside the main axis and having, at a first end, a head and, at a second end, a threaded portion, and

a second nut configured to be screwed onto the threaded portion of the fail-safe axis.

According to the invention, the fail-safe axis and the first nut are linked by an axial link configured to translationally immobilize, relative to one another, the fail-safe axis and the first nut, while allowing a rotational movement of one, relative to the other, of the first nut and of the fail-safe axis.

The invention makes it possible to avoid having the fail-safe axis exit from the main axis if the second nut is not screwed onto the fail-safe axis.

In addition, since the first nut and the fail-safe axis are linked, the fail-safe axis is necessarily present in the main axis when the first nut is screwed onto the main axis.

According to another feature, the head of the fail-safe axis is pressed against the first nut of the main axis.

According to another feature, the first nut comprises:

a tubular body provided, on an inner face, with a threading configured to be screwed onto the threaded portion of the main axis,

a head secured to a first end of the tubular body,

an extension secured to a second end of the tubular body, protruding relative to the second end of the main axis when the first nut is screwed and tightened.

According to another feature, the extension has an inner cylindrical surface with an inner diameter greater than the inner diameter of the main axis and less than the outer diameter of the threaded portion of the main axis, a terminal face opposite the tubular body and a transverse face linking the inner cylindrical surface of the extension and the inner face of the tubular body, the transverse face and the inner face of the tubular body delimiting a housing configured to house the second end of the main axis.

According to a first embodiment, the axial link comprises a circlip, a first groove on the fail-safe axis, configured to partially house the circlip and a second groove on the first nut, configured to partially house the circlip.

According to this first embodiment, the first and second grooves are positioned so that the first nut is in contact against the head of the fail-safe axis when the fail-safe axis and the first nut are translationally immobilized by the circlip.

According to a second embodiment, the axial link comprises a retaining ring and a groove on the fail-safe axis configured to partially house the retaining ring.

According to this second embodiment, the groove is positioned relative to the head of the fail-safe axis in such a way that the first nut is in contact with the head of the fail-safe axis when the fail-safe axis and the first nut are translationally immobilized by the retaining ring.

Another subject of the invention is an aircraft engine attachment comprising a swivel axis according to the invention and an aircraft which comprises the engine attachment.

### BRIEF DESCRIPTION OF THE DRAWINGS

Other features and advantages will emerge from the following description of the invention, a description given purely by way of example, in light of the attached drawings in which:

FIG. 1 is a perspective view of an aircraft,

FIG. 2 is a schematic representation of a propulsive assembly linked to a wing which illustrates an embodiment of the prior art,

FIG. 3 is a perspective view of a rear engine attachment which illustrates an embodiment of the prior art,

FIG. 4 is a perspective cross-section of a swivel axis of an engine attachment which illustrates an embodiment of the prior art,

FIG. 5 is a perspective cross section of a swivel axis of an engine attachment which illustrates a first embodiment of the invention,

FIGS. 6A to 6E are perspective cross sections which illustrate the different steps in mounting a fail-safe axis of the swivel axis that can be seen in FIG. 5,

FIG. 7 is a perspective cross section of a swivel axis of an engine attachment which illustrates a second embodiment of the invention, and

FIG. 8 is a detail view of a fail-safe axis of the swivel axis that can be seen in FIG. 7.

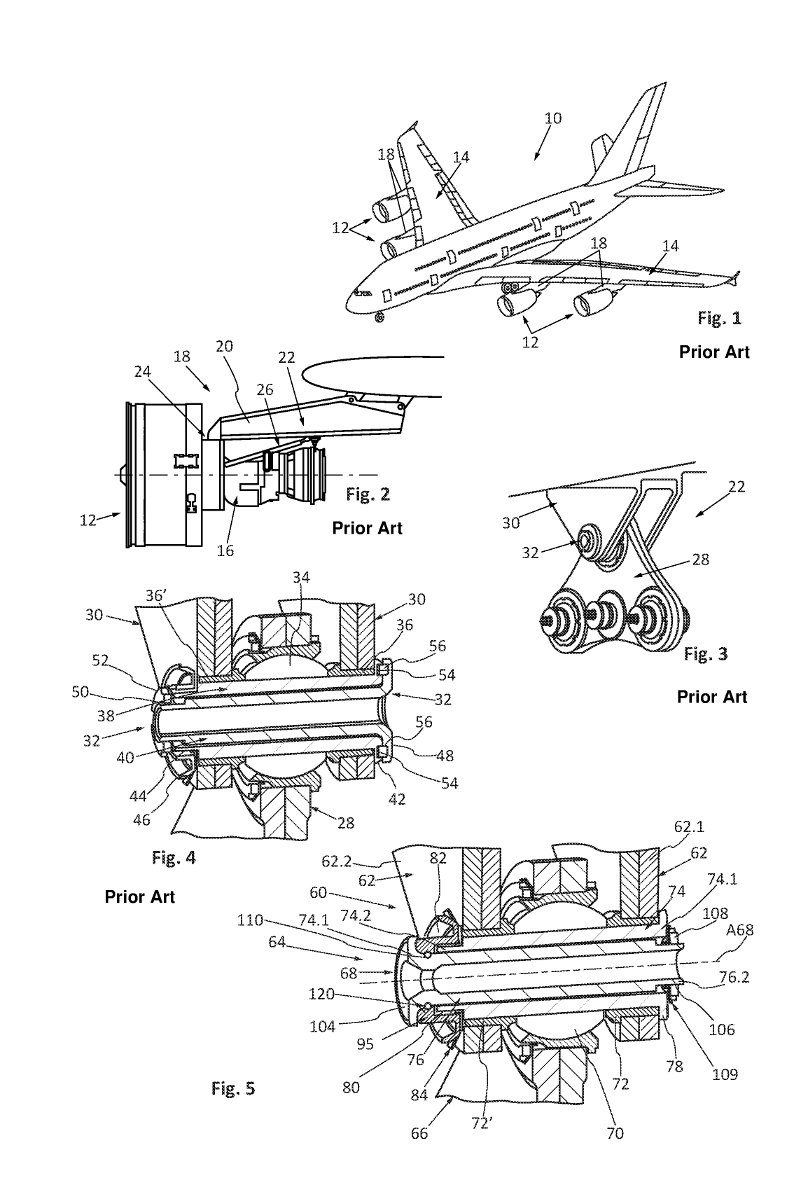

### DETAILED DESCRIPTION OF THE PREFERRED EMBODIMENTS

According to an embodiment illustrated in FIG. 5, a rear engine attachment 60 comprises a yoke joint 62, secured to a primary structure of an aircraft pylon, linked by a link 64 to a triangular plate 66 which is itself linked to an aircraft engine. The link 64 comprises a swivel axis 68, which supports, in the central part, a ball joint 70 linking the swivel axis 68 and the triangular plate 66, and two plain bearings 72, 72′, disposed on either side of the ball joint 70, linking the swivel axis 68 and the branches 62.1, 62.2 of the yoke joint 62. Thus, the swivel axis 68 of the invention can equally be mounted on the new engine attachments and on the existing ones.

Apart from the swivel axis 68, the other elements of the link 64 can be identical to those of the prior art described previously.

Moreover, although described as applied to a rear engine attachment, the swivel axis 68 of the invention can be used for the other engine attachments.

For the rest of the description, a longitudinal direction is parallel to the axis A68 of the swivel axis 68.

The swivel axis 68 comprises a first axis, called main axis 74, and a second axis, called fail-safe axis 76, coaxial to the main axis 74 and mounted inside the latter.

The outer diameter of the fail-safe axis 76 is slightly less than the inner diameter of the main axis 74 so as not to engage the fail-safe axis 76 inside the main axis 74 in normal operation.

The main axis 74 comprises, at a first end 74.1, a head 78 configured to bear in operation against a first branch 62.1 of the yoke joint 62 and/or a first plain bearing 72 and, at a second end 74.2, a threaded portion 80 onto which a nut 82 equipped with a braking system 84 is screwed. When it is tightened, this nut 82 bears against a second branch 62.2 of the yoke joint 62 and/or a second plain bearing 72′.

According to an embodiment, the head 78 takes the form of a flange ring.

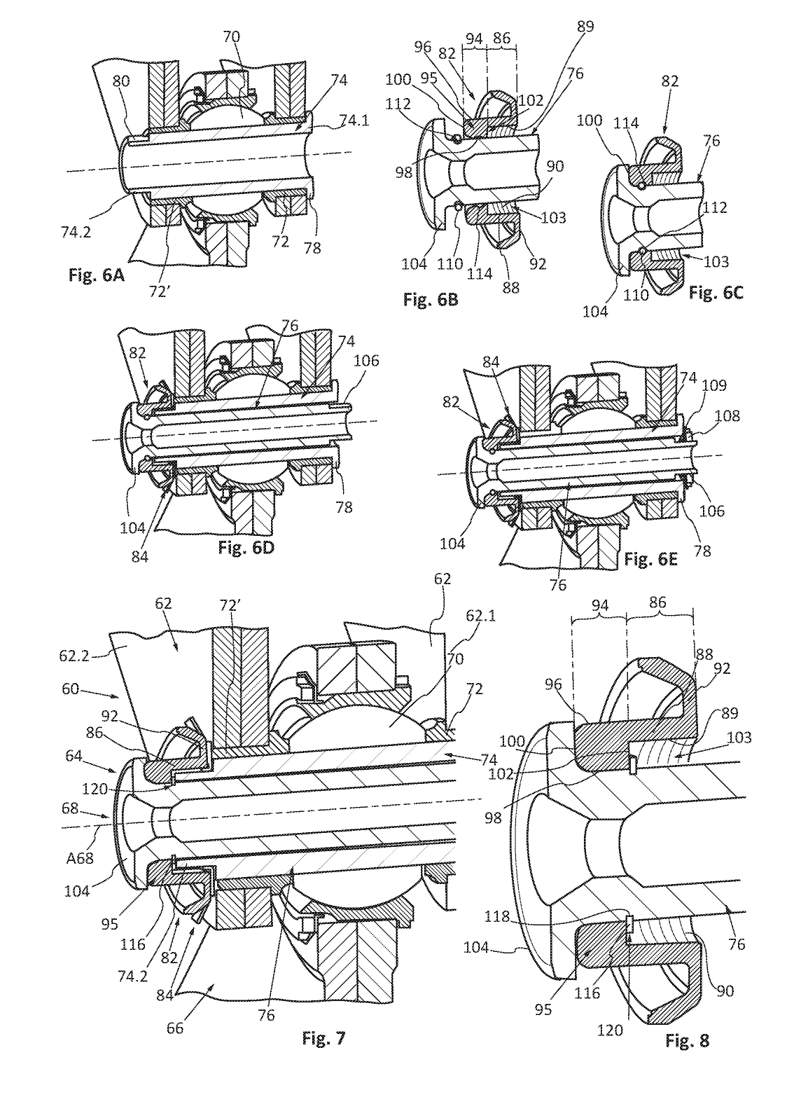

As illustrated in FIGS. 6B and 8, the nut 82 comprises a first section 86 which has a tubular body 88, provided on its inner face 89 with a threading 90 configured to be screwed onto the threaded portion 80 of the main axis 74, and a head 92, secured to a first end of the tubular body 88, configured to bear against the second branch 62.2 of the yoke joint 62 and/or the second plain bearing 72′. According to an embodiment, the head 92 takes the form of a flange ring.

This first section 86 of the nut 82 can be identical to the nut of a main axis of the prior art Similarly, the braking system 84 can be identical to that of the prior art.

According to a particular feature of the invention, the nut 82 comprises a second section 94 in the form of an extension 95 secured to a second end of the tubular body 88, protruding relative to the second end 74.2 of the main axis 74 when the nut 82 is screwed and tightened. Consequently, the main axis 74 and the tubular body 88 have lengths such that the extension 95 protrudes relative to the second end 74.2 of the main axis 74 when the nut 82 is screwed and tightened.

According to an embodiment, the extension 95 has an approximately tubular form and has an outer cylindrical surface 96 with an outer diameter substantially equal to the outer diameter of the tubular body 88 of the first section 86 and an inner cylindrical surface 98 with an inner diameter slightly greater than the inner diameter of the main axis 74 and less than the outer diameter of the threaded portion 80 of the main axis 74.

The extension 95 also has a terminal face 100 which links the outer and inner cylindrical surfaces 96, 98, opposite the first section 86, and a transverse face 102 which links the inner cylindrical surface 98 of the extension 95 and the inner face 89 of the tubular body 88 of the first section 86. Thus, this transverse face 102 corresponds to the bottom of a housing 103 delimited by the transverse face 102 and the inner face 89 of the tubular body 88 of the first section 86 and configured to house the second end 74.2 of the main axis 74.

The fail-safe axis 76 comprises, at a first end, a head 104 and, at a second end, a threaded portion 106 onto which a nut 108 equipped with a braking system 109 is screwed. This nut 108 and its braking system 109 can be identical to those of the prior art. According to an embodiment, the head 104 takes the form of a flange ring.

According to a particular feature of the invention, the head 104 of the fail-safe axis 76 is configured to bear against the nut 82 of the main axis 74 and more particularly against its terminal face 100. When it is tightened, the nut 108 bears against the head 78 of the main axis 74.

Each head 78, 104 of the main axis 74 and of the fail-safe axis 76 comprises a means (flat, imprint, or the like) for rotationally immobilizing it when tightening the nuts 82 and 108.

According to a first embodiment that can be seen in FIG. 5, the fail-safe axis 76 is linked to the nut 82 of the main axis by a circlip 110. To this end, the fail-safe axis 76 comprises a first groove 112 configured to partially house the circlip 110 and the nut 82 comprises a second groove 114 configured to partially house the circlip 110.

The second groove 114 is produced on the inner cylindrical surface 98 of the second section 94 of the nut 82.

The first groove 112 and the head 104 of the fail-safe axis are separated by a distance substantially equal to the distance separating the second groove 114 and the terminal face 100 of the nut 82 so that the terminal face 100 of the nut 82 is in contact against the head 104 of the fail-safe axis 76 when the latter and the nut 82 are translationally immobilized by the circlip 110.

The diameter of the section of the circlip 110 is substantially equal to half the difference between the diameter of the inner surface 98 of the second section 94 of the nut 82 and the outer diameter of the fail-safe axis 76.

According to a second embodiment that can be seen in FIGS. 7 and 8, the fail-safe axis 76 is linked to the nut 82 of the main axis by a retaining ring 116. To this end, the fail-safe axis 76 comprises a groove 118 configured to partially house the retaining ring 116.

The groove 118 and the head 104 of the fail-safe axis 76 are separated by a distance substantially equal to the distance separating the terminal face 100 and the transverse face 102 of the nut 82 such that the terminal face 100 of the nut 82 is in contact with the head 104 of the fail-safe axis 76 when the latter and the nut 82 are translationally immobilized by the retaining ring 116.

Whatever the embodiment, the fail-safe axis 76 and the nut 82 of the main axis 74 are linked by an axial link 120 configured to immobilize, by a translation parallel to the axis A68 of the swivel axis 68, the fail-safe axis 76 relative to the nut 82, while allowing a rotational movement, about the axis A68 of the swivel axis 68, of the nut 82 relative to the fail-safe axis 76. Once the swivel axis is mounted, the head 104 of the fail-safe axis 76 is pressed against the nut 82 of the main axis 74.

According to the first embodiment, the axial link 120 comprises the circlip and the first and second grooves 112 and 114. According to the second embodiment, the axial link comprises the retaining ring 116 and the groove 118.

The mounting of the swivel axis 68 is described in light of FIGS. 6A to 6E.

In a first step, the main axis 74 is inserted into the plain bearings 72, 72′ and the ball joint 70, as illustrated in FIG. 6A.

In a second step, the circlip 110 is positioned in the groove 112 of the fail-safe axis 76 and the nut 82 is fitted onto the fail-safe axis 76, as illustrated in FIG. 6B, until the terminal face 100 of the nut 82 bears against the head 104 of the fail-safe axis 76 and the circlip 110 is housed in the groove 114 of the nut 82, as illustrated in FIG. 6C.

In the case of a retaining ring 116, the nut 82 is fitted onto the fail-safe axis 76 until it comes into abutment against the head 104 of the fail-safe axis 76 then the retaining ring 116 is positioned in the groove 118 of the fail-safe axis 76 by using a specific plier tool, the retaining ring 116 being positioned at the bottom of the housing 103.

In a third step that can be seen in FIG. 6D, the fail-safe axis 76 is introduced into the main axis 74. When the braking system 84 of the nut 82 takes the form of a brake washer, the latter is fitted onto the fail-safe axis 76 before the latter is introduced into the main axis 74. Next, the nut 82 is screwed onto the main axis 74 until the main axis 74 is tightened. The braking system 84 is then locked to rotationally immobilize the nut 82 relative to the main axis 74.

At this stage, the fail-safe axis 76 is still rotationally free but it is translationally blocked and can no longer exit from the main axis 74.

In a fourth step that can be seen in FIG. 6E, the nut 108 and its braking system 109 are positioned on the end of the fail-safe axis 76 and the nut 108 is screwed until the fail-safe axis 76 is totally blocked. The braking system 109 is then locked to rotationally immobilize the nut 108 relative to the main axis 74.

The invention makes it possible to avoid having the fail-safe axis 76 exit from the main axis 74 if the nut 108 of the fail-safe axis 76 is not screwed.

Also, since the nut 82 of the main axis 74 and the fail-safe axis 76 are linked, the fail-safe axis 76 is necessarily present in the main axis 74 when the nut 82 is screwed onto the main axis 74.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A swivel axis for an aircraft engine attachment, comprising:
a tubular main axis which has, at a first end, a head and, at a second end, a threaded portion,
a first nut configured to be screwed onto the threaded portion of the main axis,
a fail-safe axis configured to be mounted to swivel inside the main axis and having, at a first end, a head and, at a second end, a threaded portion, and
a second nut configured to be screwed onto the threaded portion of the fail-safe axis,
wherein the fail-safe axis and the first nut are linked by an axial link configured to translationally immobilize, relative to one another, the fail-safe axis and the first nut, while allowing a rotational movement of one relative to the other of the first nut and of the fail-safe axis.

2. The swivel axis according to claim 1, wherein the head of the fail-safe axis is pressed against the first nut of the main axis.

3. The swivel axis according to claim 1, wherein the first nut comprises:
a tubular body provided on an inner face with a threading configured to be screwed onto the threaded portion of the main axis,
a head secured to a first end of the tubular body,
an extension secured to a second end of the tubular body, protruding relative to the second end of the main axis when the first nut is screwed and tightened.

4. The swivel axis according to claim 3, wherein the extension has an inner cylindrical surface with an inner diameter greater than an inner diameter of the main axis and less than an outer diameter of the threaded portion of the main axis, a terminal face opposite the tubular body and a transverse face linking the inner cylindrical surface of the extension and the inner face of the tubular body, the transverse face and the inner face of the tubular body delimiting a housing configured to house the second end of the main axis.

5. The swivel axis according to claim 1, wherein the axial link comprises a circlip, a first groove on the fail-safe axis, configured to partially house the circlip, and a second groove on the first nut, configured to partially house the circlip.

6. The swivel axis according to claim 5, wherein the first and second grooves are positioned so that the first nut is in contact against the head of the fail-safe axis when the fail-safe axis and the first nut are translationally immobilized by the circlip.

7. The swivel axis according to claim 1, wherein the axial link comprises a retaining ring and a groove on the fail-safe axis configured to partially house the retaining ring.

8. The swivel axis according to claim 7, wherein the groove is positioned relative to the head of the fail-safe axis such that the first nut is in contact with the head of the fail-safe axis when the fail-safe axis and the first nut are translationally immobilized by the retaining ring.

9. An aircraft engine attachment comprising a swivel axis according to claim 1.

10. An aircraft comprising an engine attachment according to claim 9.
